(19) United States
(12) Patent Application Publication
(10) Pub. No.: US 2009/0134737 A1
(43) Pub. Date: May 28, 2009

(54) STATOR OF ELECTRIC ROTATING MACHINE AND ELECTRIC ROTATING MACHINE

(75) Inventors: Takeo Maekawa, Okazaki-shi (JP); Akiya Shichijoh, Yatomi-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/277,417

(22) Filed: Nov. 25, 2008

(30) Foreign Application Priority Data
Nov. 26, 2007 (JP) 2007-305118

(51) Int. Cl. H02K 3/12

(52) U.S. Cl. 310/207

(57) ABSTRACT

The stator of an electric rotating machine includes a stator core formed with slots, and a stator coil constituted by a plurality of phase windings wave-wound around the stator. Each of the plurality of the phase windings is constituted by a first winding portion and a second winding wound in opposite directions. Each of the first and second winding portions includes in-slot portions accommodated in the slots, turn portions each connecting an adjacent two of the in-slot portions, and a foldback portion defined by one of the in-slot portions at which the first and second winding portions are joined to each other. The in-slot portions of the first and second winding portions are accommodated together in every one of a predetermined number of the slots adjacent in the circumferential direction such that the first and second winding portions alternate in a depth direction of the slots along the circumferential direction.

### CROSS-REFERENCE TO RELATED APPLICATION

This application is related to Japanese Patent Application No. 2007-305118 filed on Nov. 26, 2007, the contents of which are hereby incorporated by reference.

### BACKGROUND OF THE INVENTION

1. Field of the Invention

The present invention relates to a stator of an electric rotating machine and an electric rotating machine including the stator.

2. Description of Related Art

Recently, there is a growing need for high-output and compact electric rotating machine usable as an electric motor or an alternator mounted on a vehicle.

The reason is that the space in the engine compartment of a vehicle assigned to mount electric rotating machines is becoming smaller and smaller, while the output power required of each of them is becoming higher and higher.

As shown, for example, in Japanese Patent Application Laid-open No. 2004-88993, there is known an electric rotating machine in which a coil of its stator is constituted by phase windings which are successively joined so as to form a three-phase stator winding.

In this conventional electric rotating machine, the three-phase stator winding is constituted by 12 wires, and the stator has such a configuration that 24 wire ends of the 12 wires project axially from the stator. Accordingly, this conventional electric rotating machine has a problem in that since a space for electrical connection of the 24 wire ends is needed in the axial direction of the stator, the stator becomes large in size in the axial direction.

### SUMMARY OF THE INVENTION

The present invention provides a stator of an electric rotating machine comprising:

a stator core having slots formed therein along a circumference direction thereof; and

a stator coil constituted by a plurality of phase windings wave-wound around said stator core along said circumferential direction;

each of said plurality of said phase windings being constituted by a first winding portion and a second winding wound in opposite directions, each of said first and second winding portions including in-slot portions accommodated in said slots, turn portions each connecting an adjacent two of said in-slot portions, and a foldback portion defined by one of said in-slot portions at which said first and second winding portions are joined to each other,

said in-slot portions of said first and second winding portions being accommodated together in every one of a predetermined number of said slots adjacent in said circumferential direction such that said first winding portion and said second winding portion alternate in a depth direction of said slots along said circumferential direction,

a first one of said slots which accommodates said foldback portion, and a second one of said slots which is adjacent to said first one of said slots and does not accommodate one of said in-slot portions which is adjacent to said foldback portion having a depth deeper than a height of a pile of a predetermined number of said slots to be accommodated in each of said slots.

The present invention also provides a stator of an electric rotating machine comprising:

a stator core having slots formed therein along a circumference direction thereof; and

a stator coil constituted by a plurality of phase windings wave-wound around said stator core along said circumferential direction;

each of said plurality of said phase windings being constituted by a first winding portion and a second winding wound in opposite directions, each of said first and second winding portions including in-slot portions accommodated in said slots, turn portions each connecting adjacent two of said in-slot portions, and a foldback portion defined by one of said in-slot portions at which said first and second winding portions are joined to each other,

said in-slot portions of said first and second winding portions being accommodated together in every one of a predetermined number of said slots adjacent in said circumferential direction such that said first winding portion and said second winding portion alternate in a depth direction of said slots along said circumferential direction,

a first one of said slots circumferentially adjacent to a second one of said slots which accommodates said foldback portion being empty at a radial position at which said foldback portion is located,

a radial width of each of said phase windings being smaller at said turn portion connected to said foldback portion than at other portions thereof.

The present invention also provides an electric rotating machine comprising the stator as described above, and a rotor having a plurality of N-poles and S-poles alternately located along a circumferential direction thereof, said rotor being located inside or outside of said stator.

According to the present invention, it is possible to provide an electric rotating machine which is high-output and compact in size can be obtained.

Other advantages and features of the invention will become apparent from the following description including the drawings and claims.

### BRIEF DESCRIPTION OF THE DRAWINGS

In the accompanying drawings:

FIG. 1 is a diagram showing a structure of an electric rotating machine of a first embodiment of the invention;

FIG. 2 is a perspective view of a stator of the electric rotating machine of the first embodiment;

FIGS. 3A and 3B are cross-sectional views of a winding constituting a stator coil of the electric rotating machine of the first embodiment;

FIG. 4 is a diagram showing wiring of phase coils constituting the stator coil of the electric rotating machine of the first embodiment;

FIG. 5 is an expansion plan view of the windings constituting the stator coil of the electric rotating machine of the first embodiment;

FIG. 6 is a diagram explaining winding of one of phase windings of the stator coil of the electric rotating machine of the first embodiment;

FIG. 7 is a diagram explaining winding of phase coils constituting a stator coil of an electric rotating machine of a fourth embodiment of the invention;

FIG. 8 is an expansion plan view of windings constituting a stator coil of an electric rotating machine of a comparison example;

FIG. 9 is a side view of a stator of the electric rotating machine of the comparison example; and

FIG. 10 is a top view of a stator of an electric rotating machine of another comparison example.

### PREFERRED EMBODIMENTS OF THE INVENTION

### First Embodiment

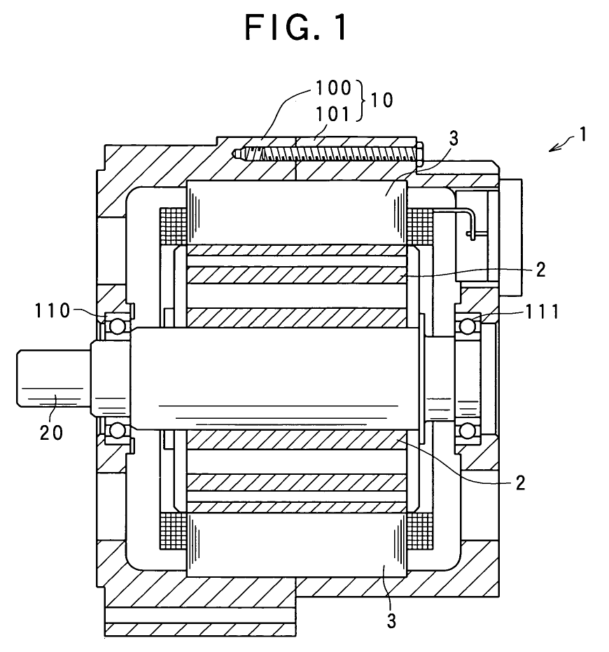

FIG. 1 is a diagram showing a structure of an electric rotating machine 1 of a first embodiment of the invention. The electric rotating machine 1 of this embodiment includes a housing 10 constituted by a pair of housing members 100 and 101 joined to each other at their opening portions, a rotor 2 fixed to a rotary shaft 20 rotatably supported by the housing 10 through bearings 110 and 111, and a stator 3 fixed to the housing 10 at a position to surround the rotor 2 within the housing 10.

The rotor 2 includes a plurality of N-poles and S-poles made of permanent magnets and alternately located along its circumferential direction on its outer peripheral side facing the inner peripheral side of the stator 3. The number of poles of the rotor 2 is set as required. In this embodiment, the rotor 2 includes eight poles (four N-poles and four S-poles).

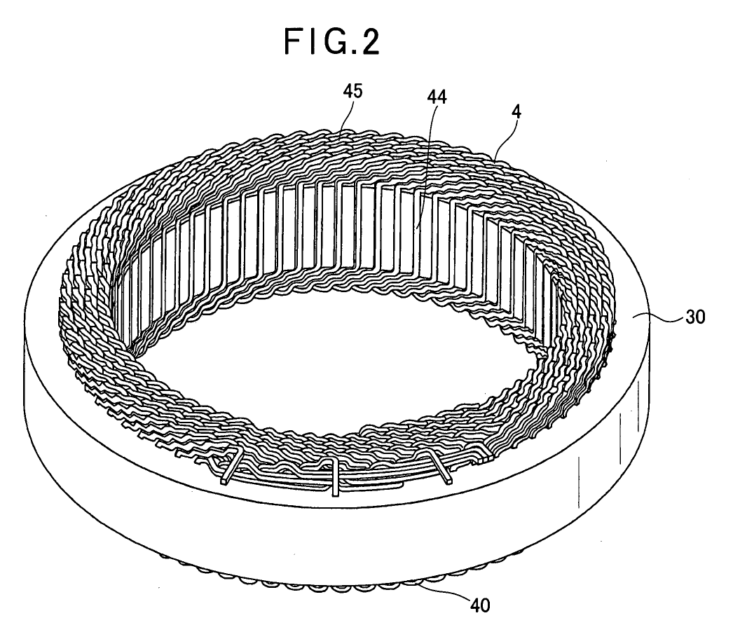

As shown in FIG. 2, the stator 3 includes a stator core 30, a three-phase coil 4 constituted by a plurality of phase windings, and insulating paper (not shown) interposed between the stator core 30 and the coil 4.

The stator core 30 is formed in an annular ring formed with a plurality of slots 31 at its inner periphery. Each of the slots 31 is formed such that its depth direction coincides with the radial direction of the stator core 30. In this embodiment, two slots 31 are formed for each pole of the rotor 2 for each phase of the coil 4. Accordingly, the stator core 30 is formed with 48 (=8×3×2) slots 31 in total.

The stator core 30 is constituted by a plurality of segment cores arranged in the circumferential direction of the stator 3. In this embodiment, the stator core 30 is constituted by 24 segment cores. Each segment core includes a teeth portion extending radially inwardly and a back core portion in which the teeth portion is formed. Each segment core defines one slot 31 by itself, and another one slot 31 with a circumferentially adjacent segment core.

The segment core is formed by laminating 410 electromagnetic steel plates having a thickness of 0.3 mm. Between each adjacent two of the electromagnetic steel plates, an insulating thin film is interposed. Alternatively, the stator core 30 may be formed of thin metal plates and the insulating films.

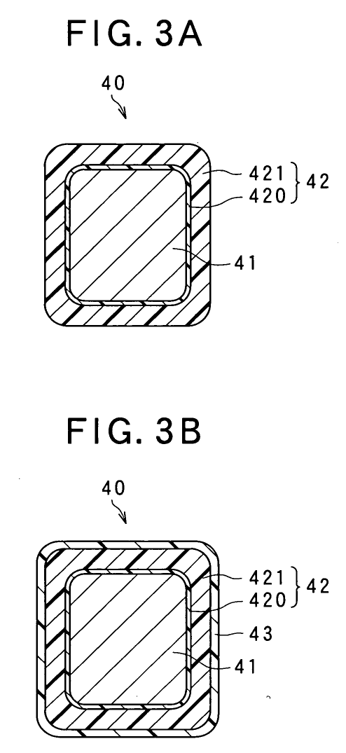

The coil 4 is formed by winding a plurality of windings 40 in accordance with a predetermined method described later. As shown in FIG. 3A, the winding 40 includes a copper conductor 41, and an insulating film 42 constituted by an inner layer 420 covering the outer surface of the conductor 41 and an outer layer 421 covering the outer surface of the inner layer 420. The thickness of the insulating film 42 including the inner and outer layers 420 and 421 is set between 100 μm and 200 μm. Since the insulating film 42 is sufficiently thick, it is not necessary to put insulating paper or the like between the windings 40 for insulation therebetween. However, insulating paper may be put between the windings 40 or between the windings 40 and stator core 30 as needed.

The outer layer 421 is formed of insulating material such as Nylon. The inner layer 420 is formed of insulating material such as polyamideimide or thermoplastic resin having a glass transition temperature higher than that of the material of the outer layer 421. Accordingly, since the outer layer 421 softens earlier than the inner layer 420 due to heat generated in the electric rotating machine, the windings 40 accommodated in the same slot 31 are heat-adhered to one other at their outer layers 421. As a result, since the windings 40 accommodated in the same slot 31 become integrated together to be a rigid body, the mechanical strength of the windings 40 increases. In addition, if excessive vibration occurs, since the adhered portion between the inner layer 420 and the outer layer 421 peels off earlier than the adhered portion between the inner layer 420 and the conductor 41, the adhesion between the inner layer 420 and the conductor 41 can be maintained to thereby ensure the insulation.

As shown in FIG. 3B, the insulating film 42 constituted by the inner layer 420 and the outer layer 421 may be covered by a fusion material 43 made of, for example, epoxy resin. In this case, since the fusion material 43 fuses earlier than the insulating film 42 due to heat generated in the electric rotating machine, the windings 40 accommodated in the same slot 31 heat-adhere to one another through their fusion materials 43. As a result, since the windings 40 accommodated in the same slot 31 become integrated together to be a rigid body, the mechanical strength of the windings 40 increases. The fusion film 43 may be made of polyphenylene sulfide (PPS).

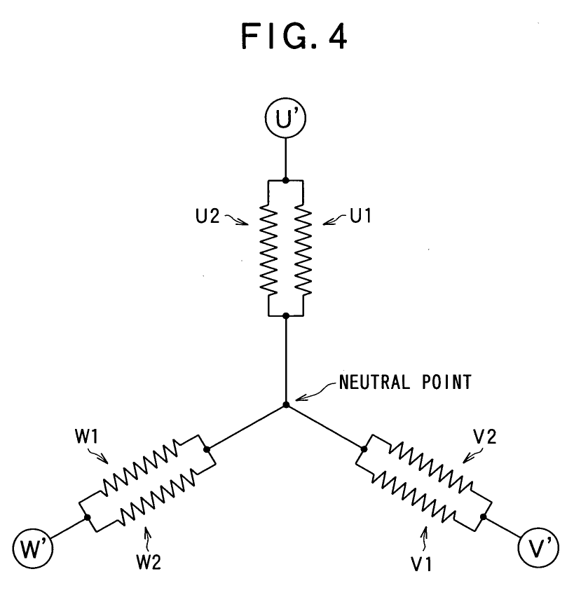

As shown in FIG. 4, the coil 4 is constituted by two sets of three-phase windings (six phase windings U1, U2, V1, V2, W1 and W2).

The coil 4 is formed by winding a plurality of the windings 40 in a predetermined shape. The windings 40 constituting the coil 4 are wave-wound in the circumferential direction on the inner periphery of the stator core 30. Each winding 40 includes linear in-slot portions 44 accommodated in the slots 31 formed in the stator core 30, and turn portions 45 each of which connects adjacent two in-slot portions 44. The in-slot portions 44 of each of the six phase windings U1, U2, V1, V2, W1 and W2 are accommodated in one of every six slots 31. The turn portions 45 are formed axially projecting from the end surfaces of the stator core 30.

That is, the coil 4 is formed by wave-winding the windings 40 in the circumferential direction in a state that one ends of windings 40 project from one of the end surfaces of the stator core 30. Each phase winding of the coil 4 is constituted by two winding portions 40a and 40b which are wave-wound differently, and connected to each other at a foldback portion 46 at which the winding direction is reversed. That is, the winding 40 is constituted including the first winding portion 40 and the second winding portion connected in series to each other. The winding portions 40a and 40b are accommodated in the same slots 31 at their in-slot portions 44 such that they alternate in depth of the slots 31 along the circumferential direction.

In this embodiment, two sets of an assembly of the winding portions 40a and 40b constitute one of three phases. In other words, in this embodiment, six sets of the assembly of the winding portions 40a and 40b constitute the coil 4 including 6 (=2×3) phase windings U1, U2, V1 V2, W1 and W2. That is, the coil 4 is constituted by 12 windings 40.

In this embodiment, the assemblies of the winding portions 40a and 40b are wound four times around the stator core 30 along the circumferential direction. That is, the coil 4 has such a configuration that the assemblies of the winding portions 40a and 40b are piled in four layers in the radial direction. Accordingly, each slot 31 accommodates 8 (=4×2) in-slot portions. The coil 4 having the above configuration is wound such that the ends of the windings 40 are located on the side of the outermost layer, and the foldback portions 46 of the windings 40 are located on the side of the innermost layer.

The turn portions 45 of the coil 4 are located on both axial end sides of the stator core 30. Each turn portion 45 is formed to have a crank-like shape with no twist in the circumferential direction at around its center. The height of the crank-like shape is about the same as the width of the winding 40, so that the turn portions 45 of the radially adjacent windings 40 do not interfere with each other to enable densely winding the turn portions 45. As a result, since the radial width of each of the coil ends of the coil 4 projecting from the end surface of the stator core 30 is reduced, it is possible to prevent the windings 40 from overhanging radially.

Furthermore, the turn portion 45 has a configuration projecting stepwise from the end surface of the stator core 30, so that the turn portion 45 does not interfere with the winding 40 projecting from the circumferentially adjacent slot 31. This makes it unnecessary to increase the height of the coil end from the end surface of the stator core 30, or to increase the radial width of the coil end for the purpose of preventing the windings 40 projecting from the circumferentially adjacent slots 31 from interfering with each other. Accordingly, this makes it possible to reduce the height of the coil end, and accordingly to prevent the coil 4 from overhanging radially.

The turn portion 45 is formed to have a shape of 4-step stairs, and the height of one step is about the same as the width (height) of the winding 40. This makes it possible to densely wind the turn portions 45, because the turn portions 45 having the same axial position can be overlapped with no gap therebetween.

The highest portion of the turn portion 45 having the stairs-like shape forms the crank-like portion. Therefore, more specifically, the turn portion 45 of the winding 40 has such a shape that two stairs-like portions are located at both sides of the crank-like portion.

The end portions of the assemblies of the winding portions 40a and 40b constituting the windings 40 project radially outwardly within the confines of the height of the coil end of the stator core 30. In more detail, the end portions the assemblies on the side of the neutral point project radially outwardly more than the end portions of the assemblies on the other side.

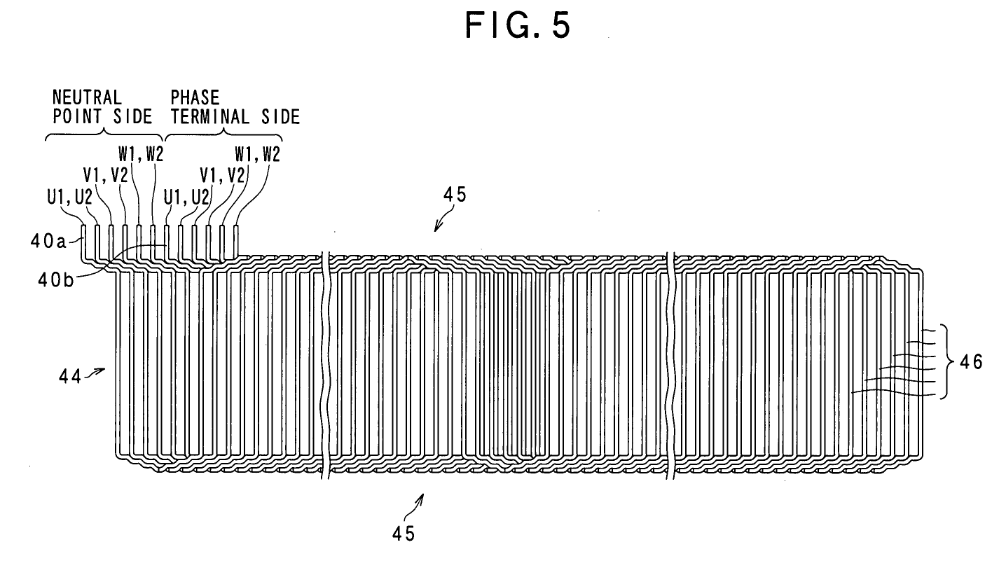

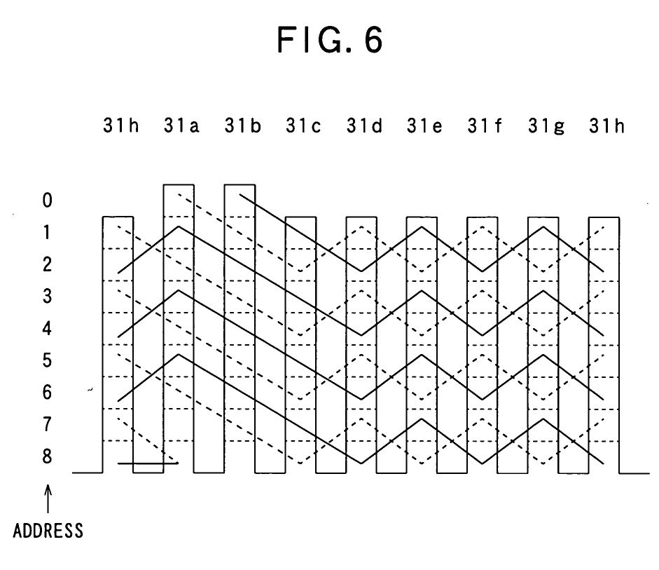

Next, the wound state of the windings 40 constituting the coil 4 is explained in detail with reference to FIGS. 5 and 6.

FIG. 5 is an expansion plan view of the coil 4. As shown in FIG. 5, the coil 4 is constituted by the six assemblies of the winding portions 40a and 40b for the six phase windings U1, U2, V1, V2, W1 and W2.

Here, the method to wind the U1-phase winding is explained with reference to FIG. 6 since this wiring method is common to all of these phase windings.

In FIG. 6, the broken lines represent the winding portions 40a, and the solid lines represent the winding portions 40b. The positions of the in-slot portions of the winding portions 40a and 40b in each slot 31 are indicated by addresses 0 to 8.

Since the rotor 2 is an eight-pole rotor, the windings 40 constituting the U1-phase winding are accommodated in eight of the slots 31 (the eight slots 31a to 31h) formed in the stator core 30. Of these eight slots, the slots 31a and 31b have a depth nearly equal to the height of nine piled in-slot portions 44. The other slots 31c to 31h have a depth nearly equal to the height of eight piled in-slot portions 44. The assembly is formed in a state of 8 in-slot portions being piled in the depth direction in each slot. In each slot, addresses having a larger value indicate a deeper position from the slot opening. In the slots 31a and 31b, the deepest accommodating space is indicated by an address of 0.

The assembly constituting the U1-phase winding is constituted by the winding portions 40a and 40b joined to each other. The end portion of the winding portion 40a is connected to the neutral point of the stator 3, and the end portion of the winding portion 4b is connected to the U1-phase terminal.

As shown in FIG. 6, the winding portion 40a is accommodated in the address 0 of the slot 31a at its in-slot portion 44 closest to the neutral point, and then accommodated in the address 1 of the slot 31b, in the address 2 of the slot 31c, and in the address 1 of the slot 31d at its in-slot portions 44, respectively. Thereafter, it is accommodated in the address 2 and the address 1 in an alternate manner. When the winding portion 40a makes a round in the stator core 30, it is accommodated in the address 1 of the slot 31h at its in-slot portion 44.

Likewise, the winding portion 40b is accommodated in the address 0 of the slot 31b at its in-slot portion 44 closest to the phase terminal, and then accommodated in the address 1 of the slot 31c, in the address 2 of the slot 31d, and in the address 1 of the slot 31e at its in-slot portions 44, respectively. Thereafter, it is accommodated in the address 2 and the address 1 in an alternate manner. When the winding portion 40b makes a round in the stator core 30, it is accommodated in the address 2 of the slot 31h at its in-slot portion 44.

The depth positions in the slots 31 of the in-slot portions 44 of the winding portions 40a and 40b change places with each other as they go from the slot 31c to 31h.

The winding portion 40a accommodated in the address 1 of the slot 31h at its in-slot portion 44 is then accommodated in the address 2 of the slot 31a, in the address 3 of the slot 31b, in the address 4 of the slot 31c, and in the address 3 of the slot 31d at its in-slot portions 44, respectively. Thereafter, it is accommodated in the address 4 and the address 3 in an alternate manner. When the winding portion 40a makes another round in the stator core 30, it is accommodated in the address 3 of the slot 31h at its in-slot portion 44.

The winding portion 40b accommodated in the address 2 of the slot 31h at its in-slot portion 44 is then accommodated in the address 1 of the slot 31a, in the address 2 of the slot 31b, in the address 3 of the slot 31c, and in the address 4 of the slot 31d at its in-slot portions 44, respectively. Thereafter, it is accommodated in the address 3 and the address 4 in an alternate manner. When the winding portion 40b makes another round in the stator core 30, it is accommodated in the address 4 of the slot 31h at its in-slot portion 44.

The winding portion 40a accommodated in the address 3 of the slot 31h at its in-slot portion 44 is then accommodated in the address 4 of the slot 31a, in the address 5 of the slot 31b, in the address 6 of the slot 31c, and in the address 5 of the slot 31d at its in-slot portions 44, respectively. Thereafter, it is accommodated in the address 6 and the address 5 in an alternate manner. When the winding portion 40a makes another round in the stator core 30, it is accommodated in the address 5 of the slot 31h at its in-slot portion 44.

The winding portion 40b accommodated in the address 4 of the slot 31h at its in-slot portion 44 is then accommodated in the address 3 of the slot 31a, in the address 4 of the slot 31b, in the address 5 of the slot 31c, and in the address 6 of the slot 31d at its in-slot portions 44, respectively. Thereafter, it is accommodated in the address 5 and the address 6 in an alternate manner. When the winding portion 40b makes another round in the stator core 30, it is accommodated in the address 6 of the slot 31h at its in-slot portion 44.

The winding portion 40a accommodated in the address 5 of the slot 31h at its in-slot portion 44 is then accommodated in the address 6 of the slot 31a, in the address 7 of the slot 31b, in the address 8 of the slot 31c, and in the address 7 of the slot 31d at its in-slot portions 44, respectively. Thereafter, it is accommodated in the address 8 and the address 7 in an alternate manner. When the winding portion 40a makes another round in the stator core 30, it is accommodated in the address 7 of the slot 31h at its in-slot portion 44.

The winding portion 40b accommodated in the address 6 of the slot 31h at its in-slot portion 44 is then accommodated in the address 5 of the slot 31a, in the address 6 of the slot 31b, in the address 7 of the slot 31c, and in the address 8 of the slot 31d at its in-slot portions 44, respectively. Thereafter, it is accommodated in the address 7 and the address 8 in an alternate manner. When the winding portion 40b makes another round in the stator core 30, it is accommodated in the address 8 of the slot 31h at its in-slot portion 44.

The winding portion 40a accommodated in the address 7 of the slot 31h at its in-slot portion 44, is then accommodated in the address 8 of the slot 31a at its next in-slot portion 44. The winding portion 40b accommodated in the address 8 of the slot 31h at its in-slot portion 44, is then accommodated in the address 8 of the slot 31a at its next in-slot portion 44.

That is, the in-slot portion 44 accommodated in the address 8 of the slot 31a forms the foldback portion 46.

The address 7 of the slot 31a and the address 8 of the slot 31b are empty.

In the stator 3 of the electric rotating machine of this embodiment, the empty space in the address 7 of the slot 31a makes handling and arranging of the turn portion 45 connected to the foldback portion 46 easy. This makes it possible to prevent the coil end of the stator 3 from projecting radially inwardly.

In addition, the first embodiment provides the following advantages.

Since each phase winding is constituted by the assembly of the winding portions 40a and 40b wound in opposite directions and joined to each other at the foldback portion 46, and accordingly, the number of the end portions of each phase winding is reduced by half, the cost for carrying out electrical connection of these end portions can be significantly reduced. In addition, since the end portions of each phase winding are located radially outwardly of the coil 4 across from the rotor 2, connection work between the end portions and external terminals is easy.

Each of the phase windings is made of the metal conductor having a rectangular cross-section, and the insulating resin film covering the metal conductor. This makes it possible to reduce the cost of manufacturing the phase windings.

### Second Embodiment

In a second embodiment of the invention, all the slots 31a to 31h have a depth sufficient to accommodate nine in-slot portions. The others are the same as the first embodiment.

In the second embodiment, the innermost accommodating space is an empty space to handle the turn portions 45. The second embodiment makes it possible to prevent the coil end from protruding radially inwardly as well as the first embodiment. In addition, since all of the slots have a sufficiently large depth, the phase windings can be wound with a high degree of flexibility.

### Third Embodiment

In the foregoing first and second embodiments, the slots are made sufficiently deep to form the space to handle the turn portions 45. However, if the number of the assemblies of the winding portions 40a and 40b is reduced, the number of the in-slot portions 44 to be accommodated in the slot 31 can be reduced for the same depth of the slot 31. Accordingly, also by reducing the number of the assemblies of the winding portions 40a and 40b, it is possible to prevent the coil end from protruding radially inwardly as well as the first and second embodiments.

### Fourth Embodiment

Although not shown in FIG. 6, circumferentially between the slot 31h and the slot 31a which accommodates the foldback portion of U1-phase winding, also the slots 31 respectively accommodating windings 40 of U2-phase, V1-phase, V2, phase, W1-phase and W2 phase are formed.

In each of theses phases, the windings 40 are wound in the same way as in U1-phase described above. Accordingly, when the connection of the in-slot portions between the slot 31h and the slot 31a of U1-phase are made by the turn portion 45, this turn portion 45 interferes with equivalent turn portions 45 of other phases.

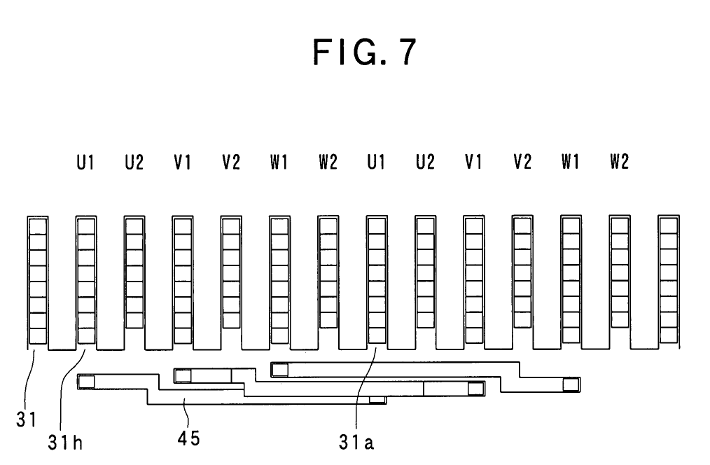

To solve this problem, in this embodiment, the number of turns of the winding 40 of U2-phase is set smaller than that of U1-phase. In more detail, as shown in FIG. 7, the innermost accommodating space of each of the slots For accommodating the winding 40 of U2-phase is empty. Likewise, the number of turns of the winding 40 of V2-phase is set smaller than that of V1-phase, and the number of turns of the winding 40 of W2-phase is set smaller than that of W1-phase.

Furthermore, in this embodiment, the turn portion 45 extending between the slots 31h and 31a of U1-phase is formed to have a crank-like shape, and to have one-half the axial thickness of the in-slot portions 45.

By forming the turn portions 45 in a crank-like shape, it is possible to prevent them from interfering with equivalent turn portions 45 of other phases.

Although the turn portion 45 connected to the foldback portion 46 is made shorter in its axial width in this embodiment, there occurs no deterioration in electrical characteristic in this turn portion, because its radial width is set to such a value that its cross sectional area is the same as that of the in-slot portions.

Accordingly, also this embodiment makes it possible to prevent the coil end from protruding radially inwardly. In addition, since this embodiment makes it possible that all the slots have the same depth, the manufacturing cost of the stator core can be reduced.

### Comparison Example 1

In the foregoing embodiments, each phase winding of the coil 4 is constituted by the assemblies of the winding portions 40a and 40b joined to each other. In the comparison example 1, the coil 4 is differently constituted without using such an assembly.

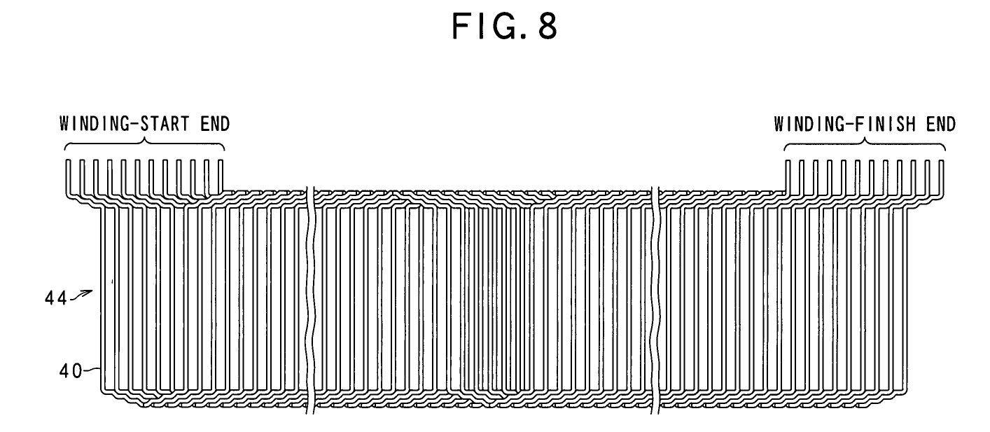

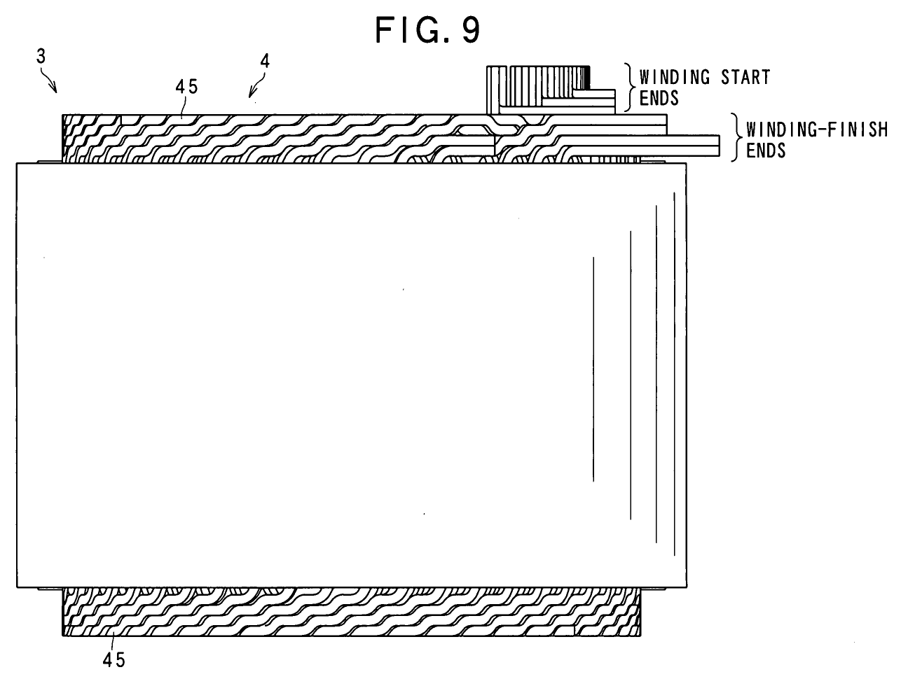

FIG. 8 is an expansion plan view of the coil 4 in this comparison example 1. As shown in FIG. 8, in this example, the winding-start ends and the winding-finish ends of the windings 40 constituting the coil 4 are located respectively on the inner peripheral side and the outer peripheral side of the stator core. Accordingly, the winding-finish ends of the windings 40 have to be extended outwardly of the coil end for their electrical connections as shown in FIG. 9.

Since the coil 4 is constituted by a number of the windings 40, and accordingly, it takes much time and a lot of labor to handle the winding-finish ends of the windings 40, the manufacturing cost increases.

In addition, since the winding-finish ends of the windings 40 have to be located axially outside the coil end, the coil 4 becomes bulky.

In contrast, in the foregoing embodiments of the invention, since the coil 4 is constituted by the assemblies of the winding portion 40a and the winding portion 40b joined through the foldback portion 46, the ends of the assemblies of the winding portion 40a and the winding portion 40b do not project from the coil end. This makes it possible to make the stator 3 compact in size.

### Comparison Example 2

In the comparison example 2, no space to handle the turn portions 45 connected to the foldback portions 46 is provided.

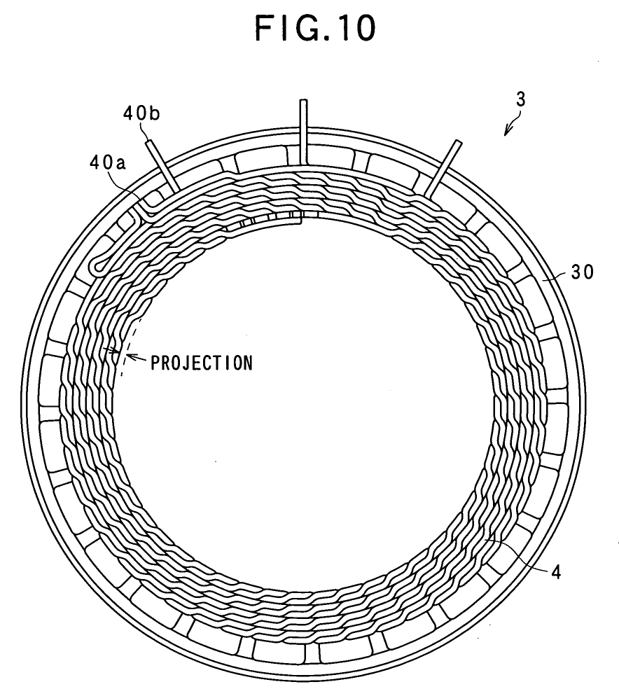

FIG. 10 is a top view of the stator 3 in this comparison example 2. In this example, since there is no space to handle the turn portions 45 connected to the foldback portion 46, each turn portion 45 located on the innermost peripheral side projects radially inwardly. In this example, assembling work of the rotor 2 becomes difficult.

In contrast, in the foregoing embodiments of the invention, since the windings 40 do not project radially inwardly toward the rotor 2, there is no possibility that the coil 4 interferes with the rotor 2.

As clear from the above description, according to the invention, the stator 3 can be made compact in size, to thereby provide a high-output and compact electric rotating machine.

The above explained preferred embodiments are exemplary of the invention of the present application which is described solely by the claims appended below. It should be understood that modifications of the preferred embodiments may be made as would occur to one of skill in the art.

What is claimed is:

1. A stator of an electric rotating machine comprising:
a stator core having slots formed therein along a circumference direction thereof; and
a stator coil constituted by a plurality of phase windings wave-wound around said stator core along said circumferential direction;
each of said plurality of said phase windings being constituted by a first winding portion and a second winding wound in opposite directions, each of said first and second winding portions including in-slot portions accommodated in said slots, turn portions each connecting an adjacent two of said in-slot portions, and a foldback portion defined by one of said in-slot portions at which said first and second winding portions are joined to each other,
said in-slot portions of said first and second winding portions being accommodated together in every one of a predetermined number of said slots adjacent in said circumferential direction such that said first winding portion and said second winding portion alternate in a depth direction of said slots along said circumferential direction,
a first one of said slots which accommodates said foldback portion, and a second one of said slots which is adjacent to said first one of said slots and does not accommodate one of said in-slot portions which is adjacent to said foldback portion having a depth deeper than a height of a pile of a predetermined number of said slots to be accommodated in each of said slots.

2. The stator according to claim 1, wherein all of said slots formed in said stator core have said depth deeper than said height.

3. The stator according to claim 1, wherein the number of said in-slot portions to be piled in said first one of said slots and said second one of said slots is smaller than the others of said slots.

4. The stator according to claim 1, wherein each of said plurality of said phase windings is made of a metal conductor having a rectangular cross-section, and an insulating resin film covering said metal conductor.

5. The stator according to claim 1, wherein each of said turn portions is formed to have a crank-like shape in said circumferential direction.

6. The stator according to claim 1, wherein each of said turn portions is formed to have a stairs-like shape, a height of which from an end surface of said stator core is largest at a center portion thereof.

7. The stator according to claim 6, wherein a height of one step of said stairs-like shape is the same as a thickness of said phase windings.

8. The stator according to claim 1, wherein said in-slot portions accommodated in each of said slots are piled in a line in said depth direction.

9. The stator according to claim 1, wherein said foldback portion is located on a radially innermost side of said slot accommodating said foldback portion.

10. The stator according to claim 1, wherein both end portions of each of said plurality of said phase windings are located radially outwardly of said stator coil, said both end portions being lower than said turn portions in radial height from an outer periphery of said stator core.

11. A stator of an electric rotating machine comprising:
a stator core having slots formed therein along a circumference direction thereof; and
a stator coil constituted by a plurality of phase windings wave-wound around said stator core along said circumferential direction;
each of said plurality of said phase windings being constituted by a first winding portion and a second winding wound in opposite directions, each of said first and second winding portions including in-slot portions accommodated in said slots, turn portions each connecting an adjacent two of said in-slot portions, and a foldback portion defined by one of said in-slot portions at which said first and second winding portions are joined to each other,
said in-slot portions of said first and second winding portions being accommodated together in every one of a predetermined number of said slots adjacent in said circumferential direction such that said first winding portion and said second winding portion alternate in a depth direction of said slots along said circumferential direction,
a first one of said slots circumferentially adjacent to a second one of said slots which accommodates said foldback portion being empty at a radial position at which said foldback portion is located,
a radial width of each of said phase windings being smaller at said turn portion connected to said foldback portion than at other portions thereof.

12. The stator according to claim 11, wherein each of said plurality of said phase windings is made of a metal conductor having a rectangular cross-section, and an insulating resin film covering said metal conductor.

13. The stator according to claim 11, wherein each of said turn portions is formed to have a crank-like shape in said circumferential direction.

14. The stator according to claim 11, wherein each of said turn portions is formed to have a stairs-like shape, a height of which from an end surface of said stator core is largest at a center portion thereof.

15. The stator according to claim 14, wherein a height of one step of said stairs-like shape is the same as a thickness of said phase windings.

16. The stator according to claim 11, wherein said in-slot portions accommodated in each of said slots are piled in a line in said depth direction.

17. The stator according to claim 11, wherein said foldback portion is located on a radially innermost side of said slot accommodating said foldback portion.

18. The stator according to claim 11, wherein both end portions of each of said plurality of said phase windings are located radially outwardly of said stator coil, said both end portions being lower than said turn portions in radial height from an outer periphery of said stator core.

19. An electric rotating machine comprising a stator described in claim 1, and a rotor having a plurality of N-poles and S-poles alternately located along a circumferential direction thereof, said rotor being located inside or outside of said stator.

20. An electric rotating machine comprising a stator described in claim 11, and a rotor having a plurality of N-poles and S-poles alternately located along a circumferential direction thereof, said rotor being located inside or outside of said stator.
